(19) United States
(12) Patent Application Publication
(10) Pub. No.: US 2007/0217360 A1
(43) Pub. Date: Sep. 20, 2007

(54) METHOD FOR MAKING ACCESS POINTS ENTER PROTECTION MODES AND MOBILE STATION UTILIZING THE SAME

(75) Inventor: Cheng-Wen Tang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/556,189

(22) Filed: Nov. 3, 2006

(30) Foreign Application Priority Data
Mar. 17, 2006 (TW) 95109265

(51) Int. Cl. H04Q 7/00; H04Q 7/20

(52) U.S. Cl. 370/329; 455/403

(57) ABSTRACT

A mobile station (300) for making access points enter protection modes includes a scanning module (310), a dummy module (320), and a dummy access point (330). The scanning module scans an access point (10) not entering a protection mode. The dummy module produces the dummy access point. The dummy access point includes a data producing module (331), an interval setting module (332), and a transmitting module (333). The data producing module produces a beacon frame for triggering the access point to enter a protection mode. The interval setting module sets a beacon interval. The transmitting module broadcasts the beacon frame during each beacon interval. A method for making access points enter protection modes is also provided.

### BACKGROUND OF THE INVENTION

1. Field of the Invention

The invention relates to wireless communications, and particularly to a method for making access points enter protection modes and a mobile station utilizing the same.

2. Description of Related Art

FIG. 1 is a schematic diagram of a wireless communication system. The wireless communication system includes an access point 10, an access point 20, and a mobile station 30. A barrier 40 is located between the access points 10, 20. A scope covered by the access point 10 is a basic service set (BSS) 11, a scope covered by the access point 20 is a BSS 21, and a scope covered by the mobile station 30 is a scope 31. The mobile station 30 is an Institute of Electrical and Electronics Engineers (IEEE) 802.11g mobile station (namely a mobile station with transmission rates of 6 Mbps, 9 Mbps, 12 Mbps, 18 Mbps, 24 Mbps, 36 Mbps, 48 Mbps, and 54 Mbps). The mobile station 30 can communicate with the access point 10 and the access point 20. The access point 10 is an IEEE 802.11g access point (namely an access point with transmission rates of 6 Mbps, 9 Mbps, 12 Mbps, 18 Mbps, 24 Mbps, 36 Mbps, 48 Mbps, and 54 Mbps) or a mixed mode access point (namely an IEEE 802.11b/g access point with transmission rates of 1 Mbps, 2 Mbps, 5.5 Mbps, 11 Mbps, 6 Mbps, 9 Mbps, 12 Mbps, 18 Mbps, 24 Mbps, 36 Mbps, 48 Mbps, and 54 Mbps). Therefore, the access point 20 can activate the access point 10 to enter a protection mode to guarantee signals from the access point 10 can be received and used by any IEEE 802.11b compatible device within the BSS 11 of the access point 10 under the following two circumstances.

In a first circumstance, if the access point 20 is an IEEE 802.11b access point, any beacon frame transmitted by the access point 20 can activate access points within the scope of the access point 20 to enter protection modes.

In a second circumstance, if the access point 20 is an IEEE 802.11g access point or a mixed mode access point, a beacon frame transmitted by the access point 20 can be set to inform access points within the scope of the access point 20 to enter protection modes.

In the above circumstances, the access point 10 can enter a protection mode. However, due to the barrier 40 such as walls of FIG. 1, the access point 10 cannot receive the beacon frame transmitted by the access point 20. In addition, the mobile station 30 is also an IEEE 802.11g mode mobile station, so the conventional mobile station 30 does not have the function of informing the access point 10 to enter a protection mode. Therefore, the access point 10 will not enter a protection mode, and communication quality of the access point 10 may be deteriorated.

### SUMMARY OF THE INVENTION

An exemplary embodiment of the present invention provides a mobile station that makes access points enter protection modes. The mobile station includes a scanning module, a dummy module, and a dummy access point. The scanning module scans an access point not entering a protection mode. The dummy module produces the dummy access point. The dummy access point includes a data producing module, an interval setting module, and a transmitting module. The data producing module produces a beacon frame for triggering the access point to enter a protection mode. The interval setting module sets a beacon interval. The transmitting module broadcasts the beacon frame during each beacon interval.

Another exemplary embodiment of the present invention provides a method for making access points enter protection modes. The method includes scanning an access point by a mobile station; producing a dummy access point by the mobile station; producing a beacon frame by the dummy access point for triggering the access point to enter a protection mode; setting a beacon interval by the dummy access point; and broadcasting the beacon frame during each beacon interval by the dummy access point.

Other advantages and novel features will become more apparent from the following detailed description when taken in conjunction with the accompanying drawings, in which:

### BRIEF DESCRIPTION OF THE DRAWINGS

FIG. 1 is a schematic diagram of a wireless communication system;

FIG. 2 is a schematic diagram of a wireless communication system and functional modules of a mobile station of an exemplary embodiment of the present invention;

FIG. 3 is a schematic diagram of a beacon frame of another exemplary embodiment of the present invention;

FIG. 4 is a schematic diagram of a beacon frame of a further exemplary embodiment of the present invention; and

FIG. 5 is a flowchart of a method for making access points enter protection modes of a still further exemplary embodiment of the present invention.

### DETAILED DESCRIPTION OF THE INVENTION

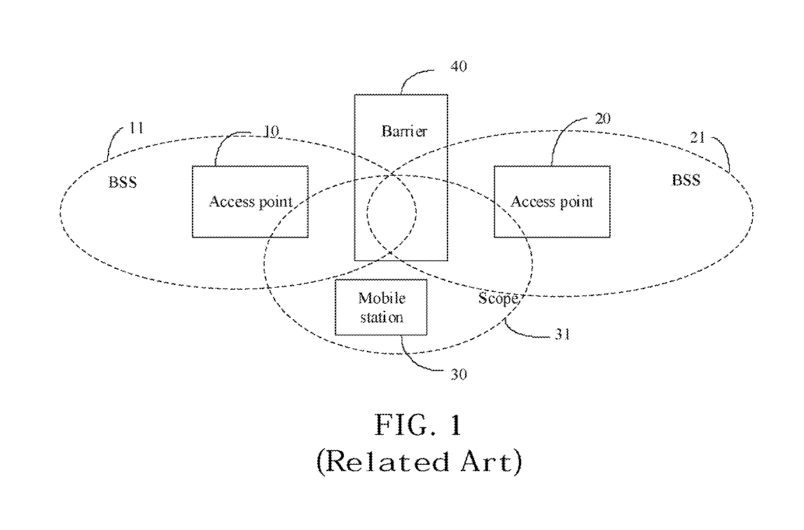

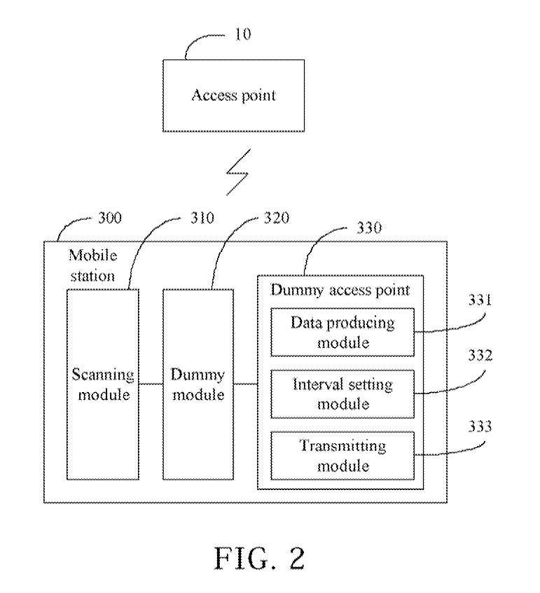

FIG. 2 is a schematic diagram of a wireless communication system and functional modules of a mobile station 300 of an exemplary embodiment of the present invention. The wireless communication system of FIG. 2 is similar to the wireless communication system of FIG. 1. Due to a barrier (such as the barrier 40 as shown in FIG. 1), an access point 10 cannot receive a beacon frame transmitted by another access point (not shown in FIG. 2). Under such conditions, the access point 10 will not enter a protection mode. In the exemplary embodiment, a mobile station 300 wirelessly communicates with the access point 10, and makes the access point 10 enter a protection mode. The mobile station 300 is an Institute of Electrical and Electronics Engineers (IEEE) 802.11g mobile station (namely a mobile station with transmission rates of 6 Mbps, 9 Mbps, 12 Mbps, 18 Mbps, 24 Mbps, 36 Mbps, 48 Mbps, and 54 Mbps). The access point 10 is an IEEE 802.11g access point (namely an access point with transmission rates of 6 Mbps, 9 Mbps, 12 Mbps, 18 Mbps, 24 Mbps, 36 Mbps, 48 Mbps, and 54 Mbps) or a mixed mode access point (namely a 802.11b/g access point with transmission rates of 1 Mbps, 2 Mbps, 5.5 Mbps, 11 Mbps, 6 Mbps, 9 Mbps, 12 Mbps, 18 Mbps, 24 Mbps, 36 Mbps, 48 Mbps, and 54 Mbps).

In the exemplary embodiment, the mobile station 300 may be a notebook computers, a personal digital assistants (PDAs), or another mobile electrical device. The mobile station 300 initially produces a dummy access point, and then broadcasts a beacon frame by the dummy access point. The beacon frame triggers the access point 10 to enter a protection mode. Therefore, communication quality of 802.11g mode of the access point 10 is ensured.

The mobile station 300, for making the access point 10 enter a protection mode, includes a scanning module 310, a dummy module 320, and a dummy access point 330. The scanning module 310 scans the access point 10 not entering a protection mode. In the exemplary embodiment, the scanning module 310 receives a beacon frame from the access point 10, and determines that the access point 10 has not entered the protection mode according to the beacon frame from the access point 10.

The dummy module 320 produces the dummy access point 330. In the exemplary embodiment, the dummy module 320 produces a dummy media access control (MAC) address for the dummy access point 330. When the mobile station 300 broadcasts a beacon frame by using the dummy MAC address, the mobile station 300 is regarded as a new access point, which is defined as the dummy access point 330. The dummy access point 330 includes a data producing module 331, an interval setting module 332, and a transmitting module 333. The data producing module 331 produces a beacon frame for triggering the access point 10 to enter a protection mode.

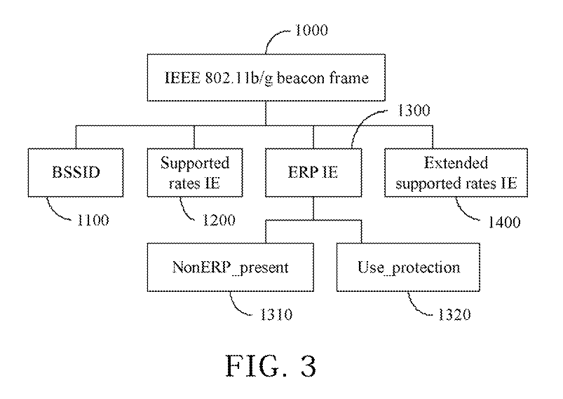

In the exemplary embodiment, the beacon frame is a IEEE 802.11b/g beacon frame 1000. Referring to FIG. 3, the IEEE 802.11b/g beacon frame 1000 includes a basic service set identifier (BSSID) 1100, a supported rates information element (IE) 1200, an extended rate physicals (PHYs) (ERP) IE 1300, and an extended supported rates IE 1400. The IEEE 802.11b/g beacon frame 1000 of the exemplary embodiment conforms to the Institute of Electrical and Electronics Engineers (IEEEE) 802.11 standard, and only required fields of the 802.11b/g beacon frame are provided in FIG. 3.

The BSSID 1100 is set to the MAC address of the dummy access point 330, namely the dummy MAC address produced by the dummy module 320. The supported rates IE 1200 indicate rates supported by the dummy access point 330. In the exemplary embodiment, the supported rates IE 1200 may be set to one or more rates among 1 Mb/s, 2 Mb/s, 5.5 Mb/s, 11 Mb/s, 6 Mb/s, 9 Mb/s, 12 Mb/s, 18 Mb/s, 24 Mb/s, 36 Mb/s, 48 Mb/s, and 54 Mb/s. The extended supported rates IE 1400 may be set to one or more rates among 6 Mb/s, 9 Mb/s, 12 Mb/s, 18 Mb/s, 24 Mb/s, 36 Mb/s, 48 Mb/s, and 54 Mbps.

The ERP IE 1300 indicates whether the dummy access point 330 enters a protection mode, and whether the 802.11b/g beacon frame 1000 can trigger other access points to enter a protection mode. The ERP IE 1300 includes a nonERP_present field 1310 and a use_protection field 1320. The nonERP_present field 1310 indicates whether there is a non IEEE 802.11g mobile station communicating with the dummy access point 330. The use_protection field 1320 indicates whether the dummy access point 330 enters a protection mode. In the exemplary embodiment, if the use_protection field 1320 is set to 1, the dummy access point 330 enters a protection mode. If the nonERP_protection field 1310 and the use_protection field 1320 are both set to 1, the beacon frame 1000 can trigger other access points to enter protection modes.

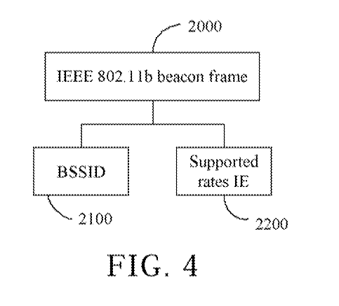

In other embodiments, the beacon frame may be an IEEE 802.11g beacon frame or an IEEE 802.11b beacon frame 2000. The IEEE 802.11g beacon frame is similar to the IEEE 802.11b/g beacon frame 1000. The difference therebetween is that the supported rates IE and the extended supported rates IE of the IEEE 802.11g beacon frame can be set to one or more rates including 6 Mb/s, 9 Mb/s, 18 Mb/s, 24 Mb/s, 36 Mb/s, 48 Mb/s, and 54 Mbps. FIG. 4 is a schematic diagram of the IEEE 802.11b beacon frame 2000 of an exemplary embodiment of the present invention. The IEEE 802.11b beacon frame 2000 includes a BSSID 2100 and a supported rates IE 2200. The BSSID 2100 is set to the MAC address of the dummy access point 330. The supported rates IE 2200 is set to one or more rates including 1 Mb/s, 2 Mb/s, 5.5 Mb/s, and 11 Mbps.

The interval setting module 332 produces a beacon interval. The transmitting module 333 broadcasts the beacon frame during each beacon interval. When receiving the beacon frame broadcast by the dummy access point 330, the access point 10 enters a protection mode.

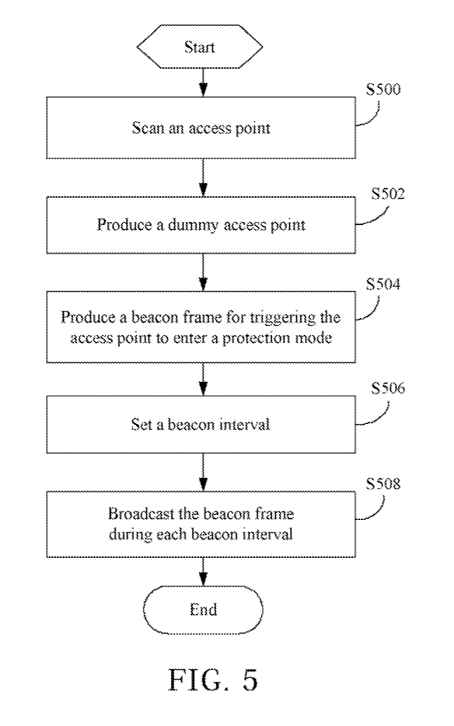

FIG. 5 is a flowchart of a method for making access points enter protection modes of an exemplary embodiment of the present invention.

In step S500, the mobile station 300 scans the access point 10. In the exemplary embodiment, the scanning module 310 of the mobile station 300 receives a beacon frame from the access point 10, and determines that the access point 10 has not entered the protection mode according to the beacon frame from the access point 10.

In step S502, the mobile station 300 produces the dummy access point 330 to communicate with the access point 10. In the exemplary embodiment, the dummy module 320 of the mobile station 300 produces a dummy MAC address to represent the dummy access point 330. When the mobile station 300 broadcasts a beacon frame by using the dummy MAC address, the mobile station 300 is regarded as a new access point, which is defined as the dummy access point 330.

In step S504, the dummy access point 330 produces a beacon frame for triggering the access point 10 to enter a protection mode. In the exemplary embodiment, the data producing module 331 of the dummy access point 330 produces the beacon frame. In the exemplary embodiment, the beacon frame is an IEEE 802.11b/g beacon frame 1000 including a BSSID 1100, a supported rates IE 1200, an ERP IE 1300, and an extended supported rates IE 1400.

The BSSID 1100 is set to the MAC address of the dummy access point 330. The supported rates IE 1200 indicates rates supported by the dummy access point 330. In the exemplary embodiment, the supported rates IE 1200 may be set to one or more rates including 1 Mb/s, 2 Mb/s, 5.5 Mb/s, 11 Mb/s, 6 Mb/s, 9 Mb/s, 12 Mb/s, 18 Mb/s, 24 Mb/s, 36 Mb/s, 48 Mb/s, and 54 Mb/s. The extended supported rates IE 1400 may be set to one or more rates including 6 Mb/s, 9 Mb/s, 12 Mb/s, 18 Mb/s, 24 Mb/s, 36 Mb/s, 48 Mb/s, and 54 Mbps.

The ERP IE 1300 indicates whether the dummy access point 330 enters a protection mode, and whether the beacon frame 1000 can trigger other access points to enter protection modes. The ERP IE 1300 includes a nonERP_present field 1310 and a use_protection field 1320. In the exemplary embodiment, if the use_protection field 1320 is set to 1, the dummy access point 330 enters a protection mode. If the nonERP_protection field 1310 and the use_protection field 1320 are both set to 1, the beacon frame 1000 can trigger other access points to enter protection modes.

In other embodiments, the beacon frame may be an IEEE 802.11g beacon frame or an IEEE 802.11b beacon frame 2000.

In step S506, the dummy access point 330 sets a beacon interval. In the exemplary embodiment, the interval setting module 332 of the dummy access point 330 produces the beacon interval.

In step S508, the dummy access point 330 broadcasts the beacon frame during each beacon interval. In the exemplary embodiment, the transmitting module 333 of the dummy access point 330 broadcasts the beacon frame during each beacon interval. When receiving the beacon frame, the access point 10 enters a protection mode.

The mobile station 300 of the exemplary embodiment can trigger the access point 10 to enter the protection mode, so communication quality of 802.11g mode of the access point 10 is ensured.

Alternatively, the mobile station 300 of another exemplary embodiment can trigger the access point 10 to enter the protection mode by means of creating a dummy mobile station compatible to IEEE 802.11b standard, instead of a dummy access point, to communicate with the access point 10. The access point 10 will automatically enter the protection mode when it detects the dummy mobile station is roaming in its BSS 11.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A mobile station, for making access points enter protection modes, comprising:
a scanning module, for scanning an access point not entering a protection mode; and
a dummy module for producing a dummy access point; wherein the dummy access point comprises:
a data producing module, for producing a beacon frame for triggering the access point to enter a protection mode;
an interval setting module, for setting a beacon interval; and
a transmitting module, for broadcasting the beacon frame during each beacon interval.

2. The mobile station as claimed in claim 1, wherein the mobile station is an Institute of Electrical and Electronics Engineers (IEEE) 802.11g mobile station, and the access point is an IEEE 802.11g access point.

3. The mobile station as claimed in claim 1, wherein the mobile station is an IEEE 802.11g mobile station, and the access point is an IEEE 802.11b/g access point.

4. The mobile station as claimed in claim 1, wherein the scanning module is used for receiving a beacon frame from the access point, and determining that the access point has not entered the protection mode according to the beacon frame from the access point.

5. The mobile station as claimed in claim 1, wherein the dummy module is used for producing a dummy media access control address for the dummy access point.

6. The mobile station as claimed in claim 1, wherein the beacon frame is an IEEE 802.11b/g beacon frame.

7. The mobile station as claimed in claim 1, wherein the beacon frame is an IEEE 802.11g beacon frame.

8. The mobile station as claimed in claim 1, wherein the beacon frame is an IEEE 802.11b beacon frame.

9. A method for making access points enter protection modes, comprising:
scanning an access point by a mobile station;
producing a dummy access point by the mobile station;
producing a beacon frame by the dummy access point for triggering the access point to enter a protection mode;
setting a beacon interval by the dummy access point; and
broadcasting the beacon frame during each beacon interval by the dummy access point.

10. The method as claimed in claim 9, wherein the mobile station is an Institute of Electrical and Electronics Engineers (IEEE) 802.11g mobile station, and the access point is an IEEE 802.11g access point.

11. The method as claimed in claim 9, wherein the mobile station is an IEEE 802.11g mobile station, and the access point is an IEEE 802.11b/g access point.

12. The method as claimed in claim 9, wherein the scanning step comprising:
receiving a beacon frame from the access point, and determining that the access point has not entered a protection mode according to the beacon frame from the access point.

13. The method as claimed in claim 9, wherein the step of producing a dummy access point comprises:
producing a dummy media access control address for the dummy access point.

14. The method as claimed in claim 9, wherein the beacon frame is an IEEE 802.11b/g beacon frame.

15. The method as claimed in claim 9, wherein the beacon frame is an IEEE 802.11g beacon frame.

16. The method as claimed in claim 9, wherein the beacon frame is an IEEE 802.11b beacon frame.

17. A method for triggering access points compatible to a first communication standard to enter protection modes thereof so as to allow devices compatible to a second communication standard successfully communicable with said access points, comprising the steps of:
scanning an access point compatible to a first communication standard to identify whether said access point is in a protection mode thereof;
creating a dummy device at least compatible to a second communication standard when said access point is not in said protection mode; and
communicating said dummy device with said access point in order for urging said access point to enter said protection mode.

18. The method as claimed in claim 17, wherein said dummy device is a selective one of a dummy access point and a dummy mobile station.
